(19) United States
(12) Patent Application Publication
(10) Pub. No.: US 2013/0080297 A1
(43) Pub. Date: Mar. 28, 2013

(54) METHOD AND SYSTEM FOR TRANSFORMING SALES DATA INTO AN ELECTRONIC SALES TRACKING DISPLAY

(71) Applicants: Robert Germain, JR., Naples, FL (US); Russ Thiel, Naples, FL (US)

(72) Inventors: Robert Germain, JR., Naples, FL (US); Russ Thiel, Naples, FL (US)

(21) Appl. No.: 13/240,730

(22) Filed: Sep. 22, 2011

(51) Int. Cl. G06Q 10/00

(52) U.S. Cl. 705/30

(57) ABSTRACT

A method and system for creating a real-time automated display that transforms sales data, such as sales numbers, accounting information and so forth, into an electronic format that is displayed as an electronic display on one or more video monitors. The video monitors may be located at different locations, such as on a sales floor or in a break room of an auto dealership. The electronic display may be used in businesses having commission based sales forces to track monthly sales goals and sales numbers for sales representatives and as a motivational tool.

### BACKGROUND OF THE INVENTION

This invention relates to sales tracking methods used in businesses having commission based sales forces, and more particularly to a method and system for transforming sales data into an electronic form that can then be displayed on a video monitor.

Businesses having commission based sales forces, such as automobile dealerships, commonly use displays to track monthly sales goals and sales numbers for sales representatives. These displays are typically dry erase boards or whiteboards that have to constantly be manually updated as sales are made. While displays are valuable tracking and motivational tools, the maintenance and constant updating of conventional displays is time consuming.

Therefore, a need exists for a system and method for transforming data, such as sales numbers, sales goals and so forth, into an electronic format that can be displayed on a video monitor and automatically updated as said data changes.

The relevant prior art includes the following references:

| Patent No. | | |
|---|---|---|
| (U.S. Patent References) | Inventor | Issue/Publication Date |
| 2010/0205051 | Yun | Aug. 12, 2010 |
| 2009/0240574 | Carpenter et al. | Sep. 24, 2009 |
| 2009/0187486 | Lefenfeld | Jul. 23, 2009 |
| 2009/0006118 | Pollak | Jan. 01, 2009 |
| 2008/0126231 | Santiesteban | May 29, 2008 |
| 2008/0086359 | Holton et al. | Apr. 10, 2008 |
| 2007/0299709 | Harrell et al. | Dec. 27, 2007 |
| 2007/0208637 | Cooper et al. | Sep. 06, 2007 |
| 2004/0249687 | Lowell et al. | Dec. 09, 2004 |
| 2004/0138944 | Whitacre et al. | Jul. 15, 2004 |
| 6,662,164 | Koppelman | Dec. 09, 2003 |
| 2003/0101091 | Levin et al. | May 29, 2003 |
| 2002/0169671 | Junger | Nov. 14, 2002 |
| 2002/0069144 | Palardy | Jun. 06, 2002 |
| 2002/0055894 | Hyder | May 09, 2002 |
| 6,226,621 | Warsh | May 01, 2001 |

### SUMMARY OF THE INVENTION

The primary object of the present invention is to provide a method and system for transforming sales data into an electronic display on a video monitor.

An additional object of the present invention is to provide a method and system for transforming sales data into an electronic display in which the sales data is automatically updated on the electronic display as the sales data changes.

The present invention fulfills the above and other objects by providing a method and system for creating a real-time automated display that transforms sales data, such as sales numbers, accounting information and so forth, into an electronic format that is displayed on one or more video monitors. The video monitors may be located at different locations, such as on a retail sales floor or in a break room of a wholesale or retail sales outlet. A primary video monitor preferably displays a grid having columns listing sales representatives' names in one column, gross sales for each sales representative in a separate column, month to date units sold by each sales representative in a separate column and year to date units sold by each representative in a separate column. Icons are placed in a row next to each sales representative's name to represent each unit that has been sold for the current month. The icons may be color coded to represent information, such as if the square represents a used item, a new item or a certain make or model of item. Information may also be listed in each icon, such as year, make and model of the item, the price the item was sold for and the date the item was sold. Sales representatives are preferentially listed from top to bottom in the order of most sales to least sales.

A bar graph is may be displayed on a second video monitor represents how many items have been sold in a certain period of time in relation to the sales goal for that time. The second video monitor is preferably placed in a more private location, such as a break room. The top sales representative may be listed at the top of the screen with tickers located on the bottom of the screen. Information, such as gross sales may be displayed on the second monitor only so that customers do not see confidential information on any monitors located on the sales floor. An additional feature of each electronic display is tickers that run across the video monitor showing advertising message or relaying information to sales representatives.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a flow chart showing the basic steps for creating an electronic display using the system and method of the present invention;

FIG. 2 is a perspective view of a computer environment and flow chart showing the system and method of the present invention;

FIG. 3 is a flow chart showing the steps of the present invention for opening imported text files containing sales data;

FIG. 4 is a flow chart showing the life cycle of sales data displayed on an electronic display of the present invention;

FIG. 5 is a flow chart showing the steps for transforming collected sales data into an electronic display;

FIG. 6 is a flow chart showing a count determination process for calculating sales counts and sales averages using the method and system of the present invention;

FIG. 7 is a flow chart showing the steps for creating a data model using the system and method of the present invention;

FIG. 8 is a flow chart showing the administration of the system and method of the present invention to create an electronic display;

FIG. 9 is an example of a computer environment in which the method and system of the present invention operates;

FIG. 10 is a flow chart showing the steps for creating custom display layouts using the system and method of the present invention;

FIG. 11 is an electronic display created for an automobile dealership using the system and method of the present invention; and

FIG. 12 is an electronic display created for a automobile service center using the system and method of the present invention.

### DESCRIPTION OF THE PREFERRED EMBODIMENTS

For purposes of describing the preferred embodiment, the terminology used in reference to the numbered accessories in the drawings is as follows:
101. sales data database
102. data acquisition
103. service provider data storage
104. administration
105. display
201. sales data
202. accounting system
203. computer system
204. subscriber database
205. interface/create post text files
206. FTP file transfer
207. FTP server
208. service provider's server
209. open and import text files
210. service provider's data base
211. administration
212. query results
213. XML web service
214. web server
215. web page
216. electronic monitor
301. acquire sales data/text file
302. open text file
303. determine if subscriber is active
304. close text file
305. create new file
306. create new model
307. create inventory
308. create listing for salesperson
309. create sale
310. close file
311. save file
312. delete original file
401. life cycle entry
402. display administration
403. determine eligibility
404. web page administration
405. determine sales URL
406. determine custom URL
407. iterate list of URLs
408. display next URL
409. begin URL management process
410. sales URL
411. navigate sales data
412. build display
413. display for predetermined amount of time
414. return to step 407
415. custom URL
416. navigate display to custom URL
501. determine list of eligible sales people
502. calculate MTD sales
503. calculate YTD sales
504. calculate average sales
505. retrieve CSI score
506. electronic display
507. MTD sales
508. YTD sales
509. average sales
510. CSI score
511. icon
512. salesperson name
513. number of inventory items sold
514. product information
601. sales data is searched by sales person and time period
602. number of sales are determined
603. determine if sale was shared
604. total number of sales is calculated
605. sum is returned
701. transaction record data space
702. model information data space
703. inventory information data space
704. salesperson information data space
705. sale information data space
706. system URL data space
707. custom URL data space
708. display data space
801. secure website
802. service provider
803. subscriber
804. salespeople
805. CSI scores
806. sales goals
807. information administration
808. display administration
809. URL administration
810. system URL
811. custom URL
812. data
901. service provider's server
902. Internet
903. Ethernet
904. monitor
905. hub
906. wireless access point
907. communication link
1001. request for custom display
1002. subscriber creates artwork
1003. third party creates artwork
1004. artwork supplied to service provider
1005. art work posted to web server
1006. web page created to host artwork
1007. custom URL created
1008. termination date reached
1009. artwork is archived
1010. URL is deleted from server
1011. subscriber requests reinstatement
1012. artwork retrieved
1013. web page created
1014. custom URL is active until new termination date

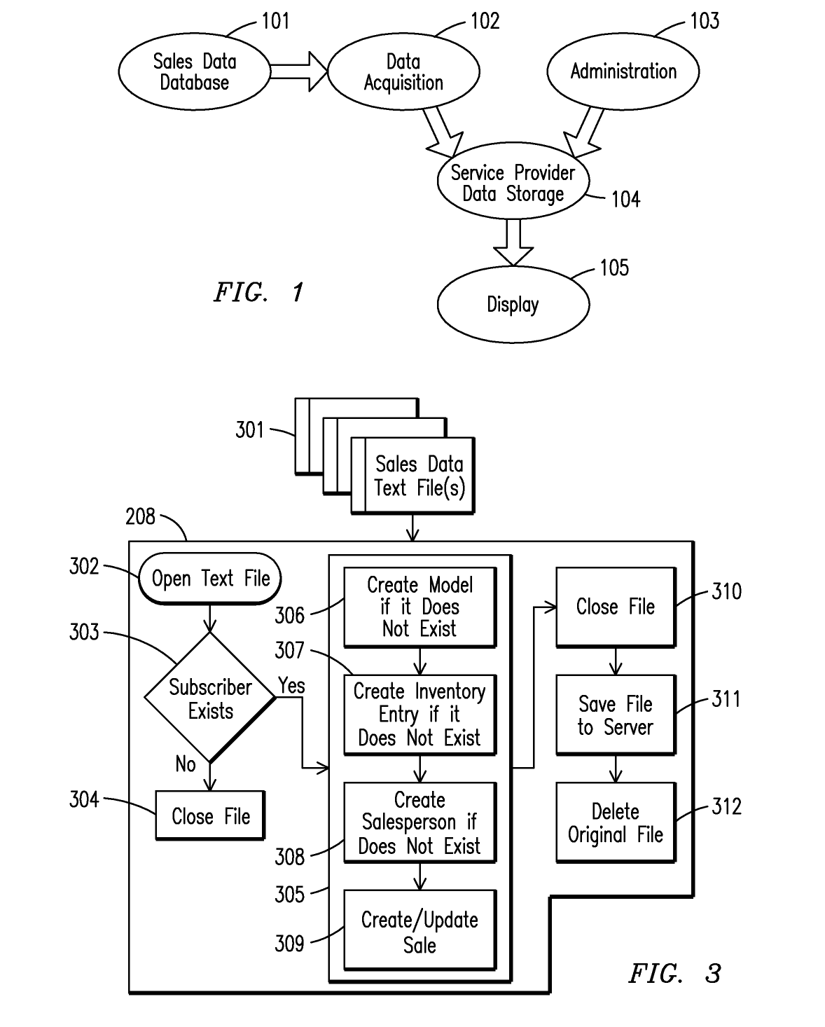

With reference to FIG. 1, a flow chart showing the basic steps for creating an electronic display using the system and method of the present invention is illustrated. First, sales data from a subscriber is entered into a sales data database 101. Sales data may include information relating to a sold product (such as price, make, etc.), the number of products sold by a sales representative, customer satisfaction index (“CSI”) information and so forth. The sales database may be a stand alone database that the subscriber enters sales data into for the sole purpose of creating an electronic display or preferably a pre-existing accounting database into which subscriber already enters sales data into for accounting purposes. Next, a service provider remotely collects the sales data from the sales data database 102 and stores the sales data in the service provider's database 103. Then, the service provider performs administration of the acquired sales data to transform the sales data into a graphical format that is arranged as an electronic display 104. Finally, the service provider electronically transmits the electronic display back to the subscriber to be displayed on one or more electronic displays located at the subscriber's location 105.

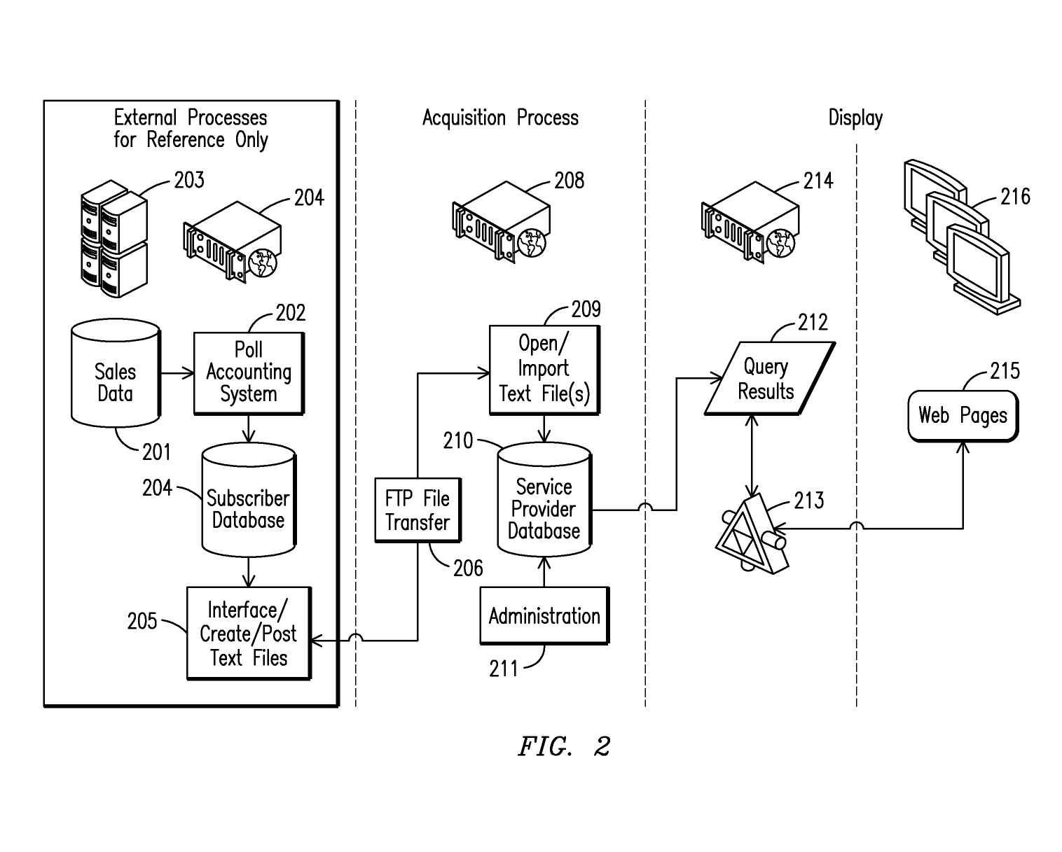

With reference to FIG. 2, an example of a computer environment in which the method and system of the present invention operates in combination with a flow chart showing the system and method of the present invention is illustrated. First, sales data 201, such as sales numbers, units sold, types of units sold, sales prices and so forth, is entered into a pre-existing poll accounting system 202 operating on a computer system 203. Then, the sales data is stored in a subscriber database 204. Then, a service provider interfaces with the accounting system 202 and creates post text files using the sales data 205. Next, the post text files are transferred 206 to the service provider's database server 208 via a file transfer protocol (“FTP”) server 207. Then, the post text files are opened and imported 209 onto the service provider's database 210. An administrator may then modify the files as needed 211. Then, the data is transformed into a graphical electronic display based on predetermined query results 212 and displayed as a web page 215 via an extensible markup language (“XML”) web service 213 through a web server 214. Finally, the web page 215 is displayed on one or more electronic monitors 216 located at the subscriber's place of business via the Internet.

With reference to FIG. 3, a flow chart showing the steps of the present invention for opening imported text files containing sales data is illustrated. First, text files containing sales data are acquired by a service provider from a subscriber's database 301, such as an accounting database, as shown in FIG. 2. Then, the service provider opens the text files 302. Next, the service provider determines if the data contained in the text file is for an active subscriber 303. If the data contained in the text file is not for an active subscriber, then the text file is closed 304. If the data contained in the text file is for an active subscriber, then a new file is created using the sales data contained in the text file 305 by creating a model 306, creating an inventory entry 307, creating a listing for the sales representative that the sales data pertains to 308, creating or updating any additional information pertaining to the sales data and so forth 309. Then, the text file is closed 310. Next, the new file is saved to the service provider's server 311. Finally, the original text file is deleted 312.

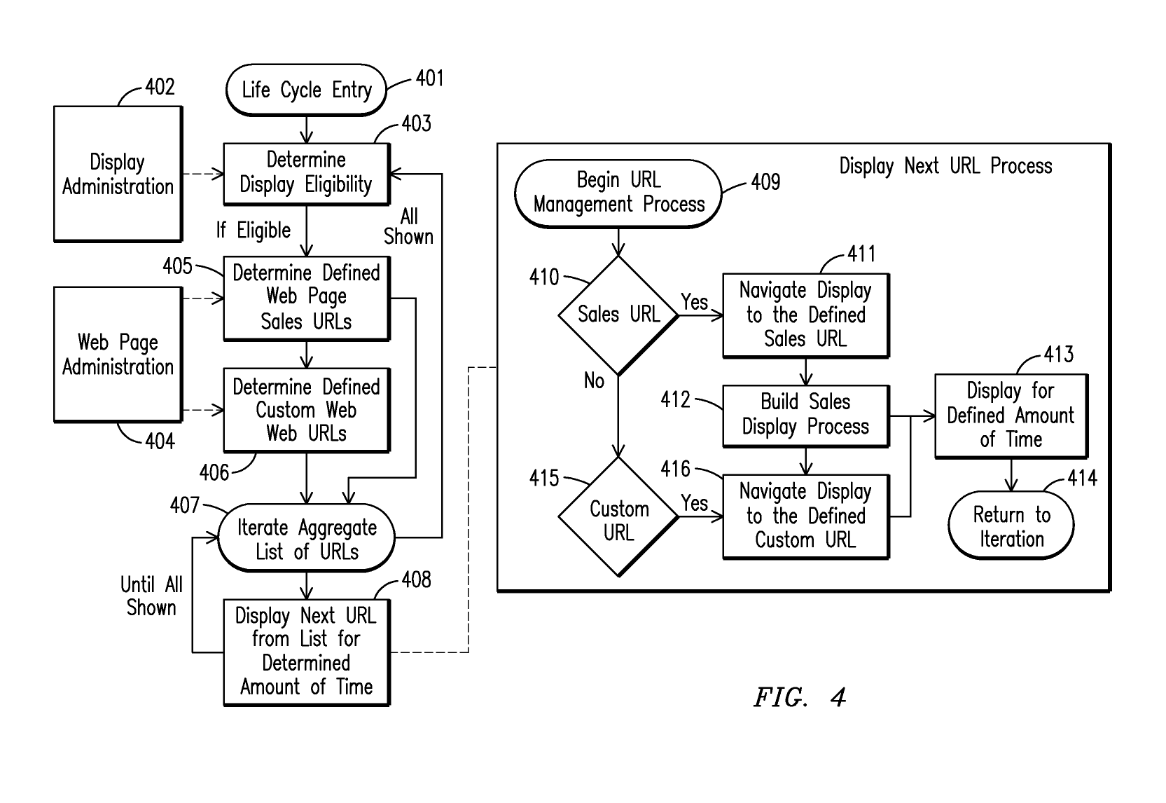

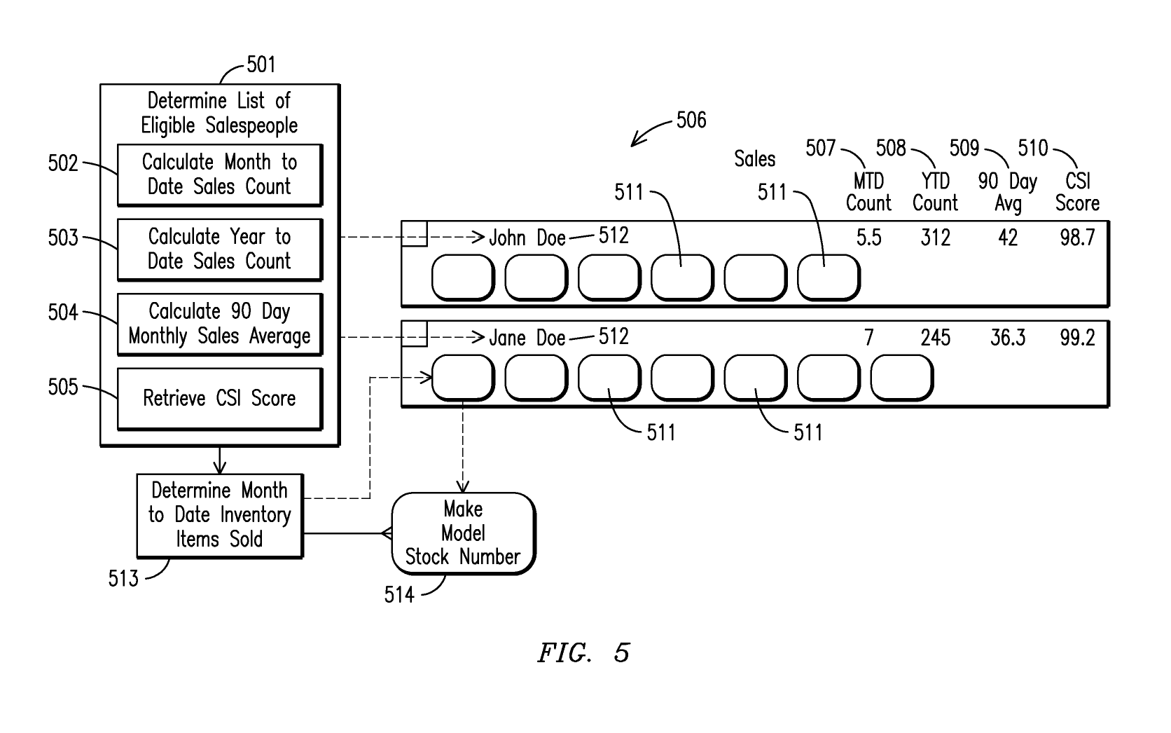

With reference to FIG. 4, a flow chart showing a life cycle of sales data displayed on an electronic display of the present invention is illustrated. First, a predetermined set of values is entered as a life cycle entry defining a start date and end date for certain sales data to be displayed on an electronic display 401. Then, display administration 402 determines the eligibility of displays depending on the current date and status of the subscriber 403. Next, web page administration 404 determines a defined system web page URL 405 or a custom web page URL 406. Then, one or more URLs are placed into a list for iteration. Each URL is displayed until the defined time limit expires 407 according to the set of values entered in previous steps 408 and according to eligibility of the subscriber. When a URL and display reach the next iteration, a URL management process is started 409; if the next URL to be displayed is a sales URL 410, then the display is navigated to the sales URL 411 and a display is formed 412 showing sales data previously described. The sales URL is then displayed as an electronic display on the URL for the defined period of time 413. After the defined period of time ends, step 407 is repeated. If the next URL to be displayed is a custom URL 414, then the display is navigated to the custom URL 415. The custom URL is then displayed as an electronic display for the defined period of time 413. After the defined period of time ends, step 407 is repeated.

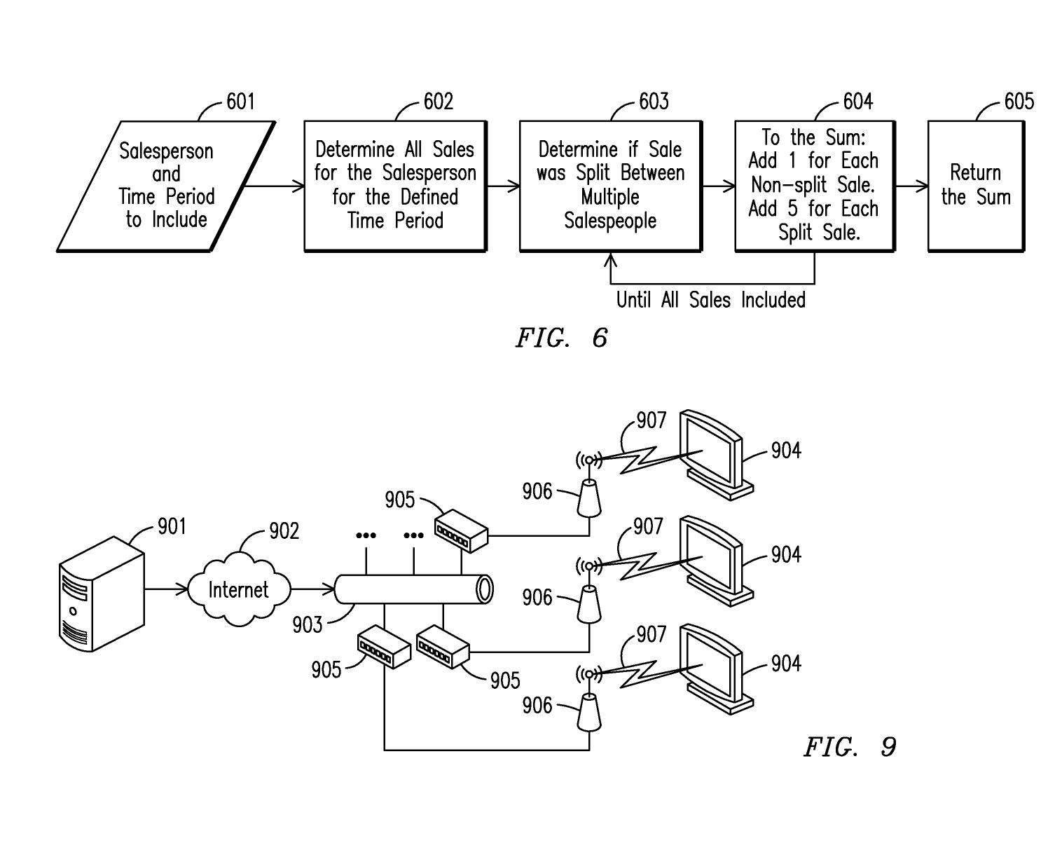

With reference to FIG. 5, a flow chart showing the steps for transforming collected sales data into an electronic display is illustrated. First, sales data is acquired by a service provider from a subscriber, as shown in FIG. 2. Then, a list of eligible or current sales representatives is determined 501. Then, the collected sales data is used to calculate a month to date sales count for each eligible sales representative 502. Next, the collected sales data is used to calculate a year to date sales count for each eligible sales representative 503. Then, the collected sales data is used to calculate a sales average over a period of time 504, such as sixty days, ninety days, etc., for each eligible sales representative. All sales counts and sales averages are calculated through a count determination process illustrated in FIG. 6. Next, CSI is obtained from the sales data 505. The information calculated in steps 502-505 is transformed into an electronic display 506 showing the month to date (“MTD”) sales 507 for each eligible sales representative, the year to date (“YTD”) sales 508 for each eligible sales representative, the average sales over a period of time 509 for each eligible sales representative and the CSI score 510 for each eligible sales representative. Finally, icons 511 for each product sold by an eligible sales representative are created and displayed in a row next to the sale's representative's name 512. The number of icons depends on the month to date inventory sold by the sales representative 513. The icon may include product information, such as make, model, stock number, price and so forth 514.

With reference to FIG. 6, a flow chart showing a count determination process for calculating sales counts and sales averages using the method and system of the present invention is illustrated. First, the sales data acquired by the service provider from the subscriber, as shown in FIG. 2, is searched for specific sales information relating to a sales representative and time period 601. Then, all sales for the sales representative made during time period are determined 602. Next, it is determined whether each sale was the sole responsibility of the sales representative or if multiple sales representatives were responsible for the sale 603. Then, the sum of sales is calculated based on the total number of sales and the sales representative percentage of responsibility for each sale 604. Finally, the sum is returned and used to create an electronic display 605.

With reference to FIG. 7, a schematic display of a data model of the system and method of the present invention is illustrated. A data space for a transaction record is provided 701. The transaction record includes data such as sales information regarding a sold product, such as make and model 702, inventory information 703 (which includes stock number color, price, model year, whether the product new or used, etc.), salesperson information 704 (which includes the name of the sale representative responsible for the sale, CSI score for the sales representative, etc.) and sale information 705 (which includes price, sale date, shared commissions, etc.). A data space is also provided for a system uniform resource locator (“URL”) on which the display time and type is controlled 706. In addition, a data space is provided for a custom URL on which display time, display type, and a date range for displaying the description 707 is included. Finally, a data space is provided for a display and information relating to the display, such as the location of the display and if the display is active 708.

With reference to FIG. 8, a flow chart showing the administration of the system and method of the present invention in which sales data is collected, organized and stored in the service provider's database is illustrated. A secure website 801 is used by the service provider 802 and subscriber 803 to control what sales data is displayed on the subscriber's electronic display. Sales data, such as sales peoples' names 804, CSI scores 805, sales goals 806 and so forth, may be updated by the service provider or subscriber through the secure administration website 807. That sales data is then used to create an electronic display having a predetermined design and layout 808. The electronic display is then saved as a URL that is either a system URL or a custom URL 809. Finally, the system URL 810 or custom URL 811 is saved in the service provider's database 812.

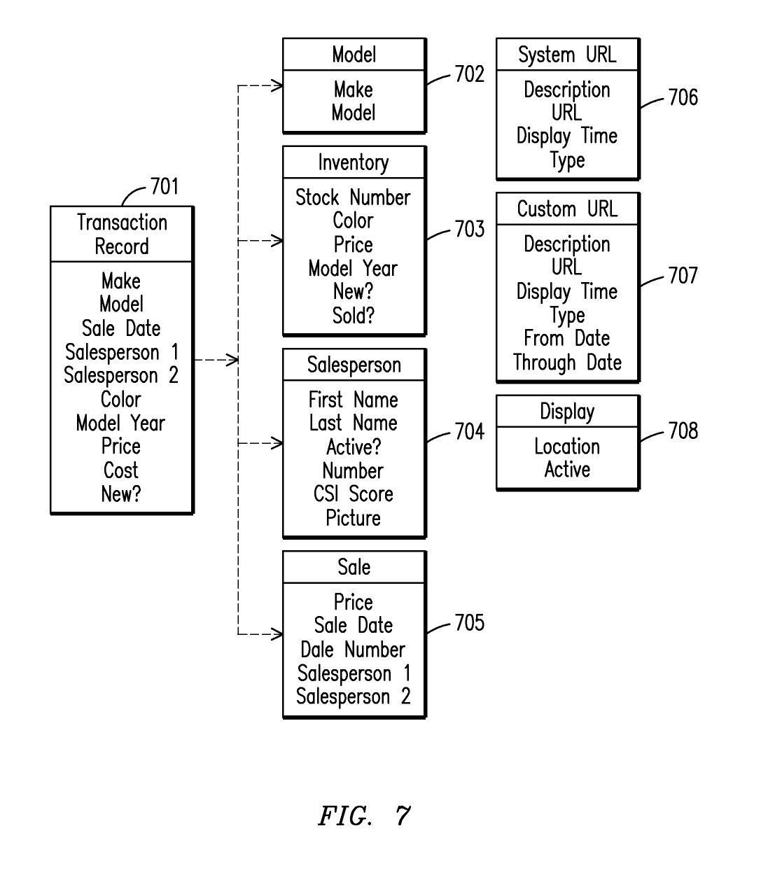

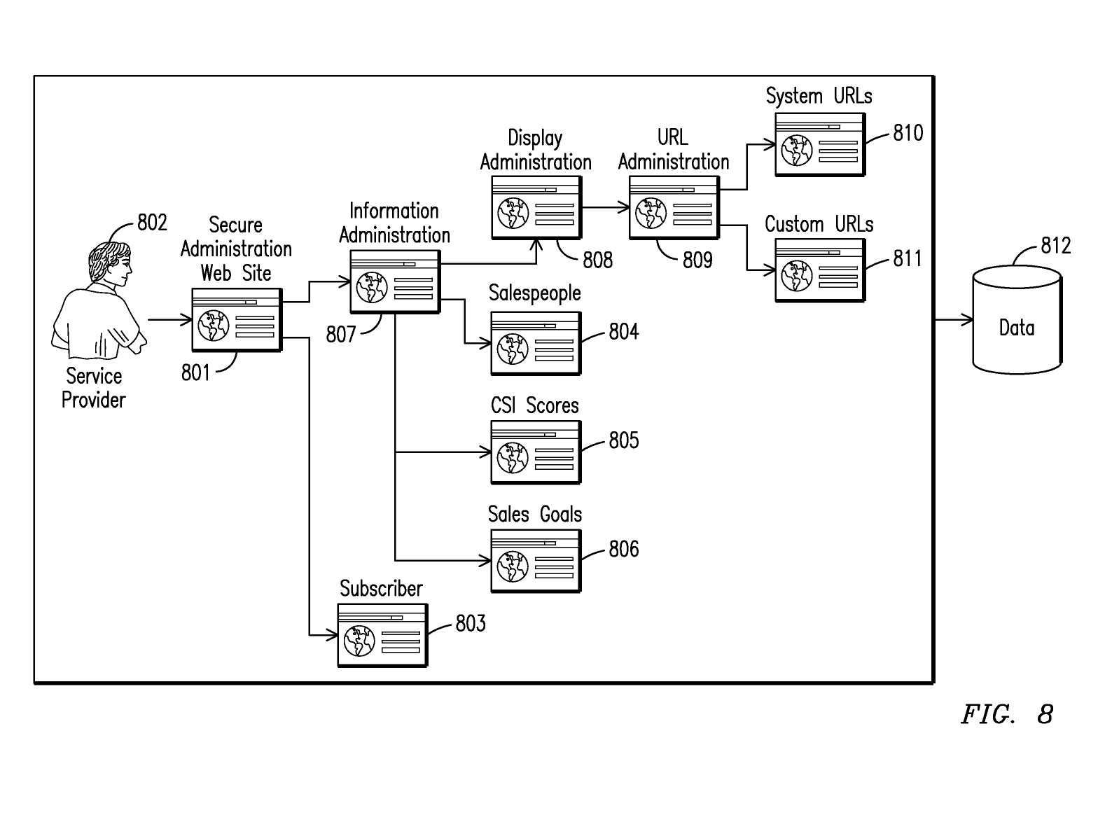

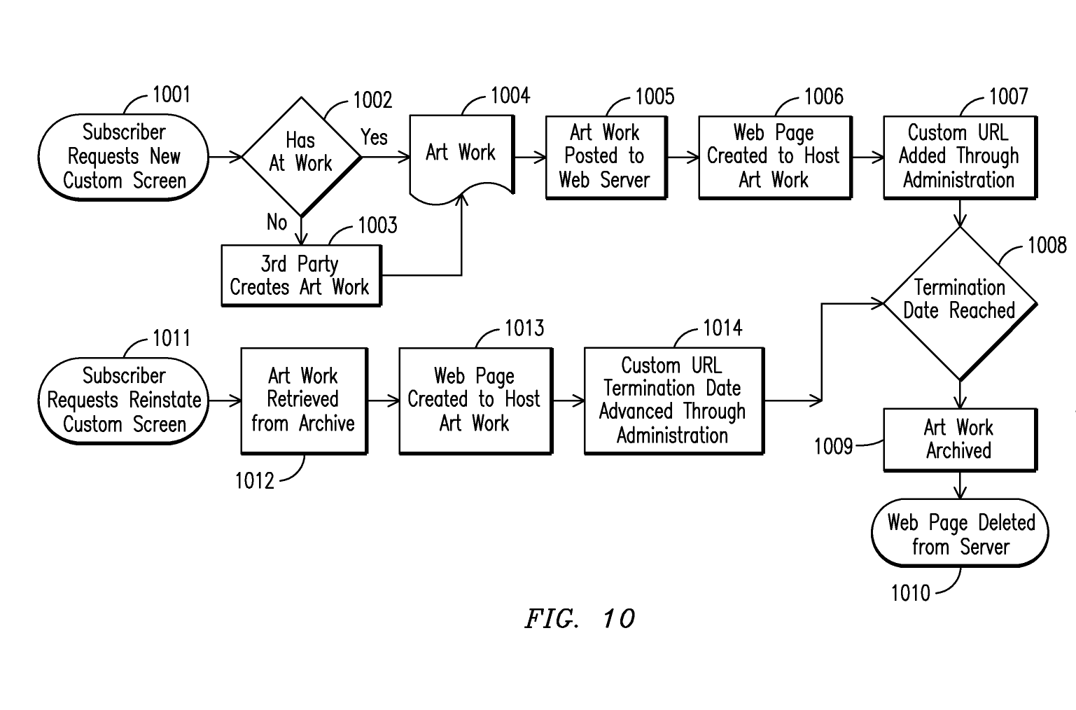

With reference to FIG. 9, an example of a computer environment in which the method and system of the present invention operates is illustrated. A service provider acquires sales data from subscribers and transforms that sales data into one or more electronic displays saved as URLs on the service provider's server 901. The subscribers then accesses the URLs through the Internet 902 and Ethernet 903 and the subscribers transmits the URLs to one or more monitors 904 via hubs 905, wireless access points 906 and communication links 907.

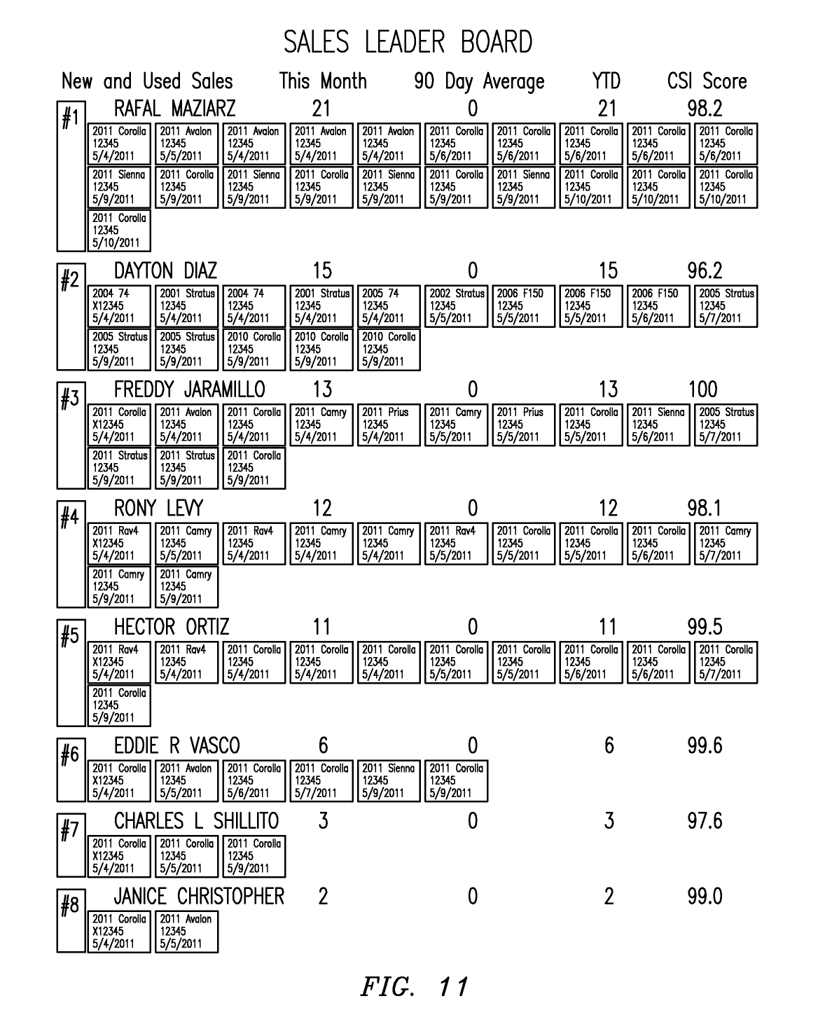

With reference to FIG. 10, a flow chart showing the steps for creating custom display layouts using the system and method of the present invention is illustrated. First, a subscriber requests a new electronic display design 1001. Then, the subscriber creates artwork for the custom electronic display 1002 or has a third-party create artwork for the custom electronic display 1003. After the service provider is supplied with the artwork 1004, the artwork is posted to the service provider's web server 1005. Next, a web page is created to host the art work 1006 and a custom URL is added through the service provider's administration 1007. The URL will display the custom screen until a termination date is reached 1008, such as a planned termination of an advertising campaign. Then, the custom screen and artwork will be archived and stored in the service provider's database 1009 and the web page will be deleted from the service provider's server 1010. If the subscriber decides to reinstate the service provider's services, then the subscriber can submit a request to reinstate the custom display 1011. Then the art work is retrieved from the database 1012 and a new web page is created 1013. Finally, the reinstated custom URL will remain active until a new termination date is reached 1014.

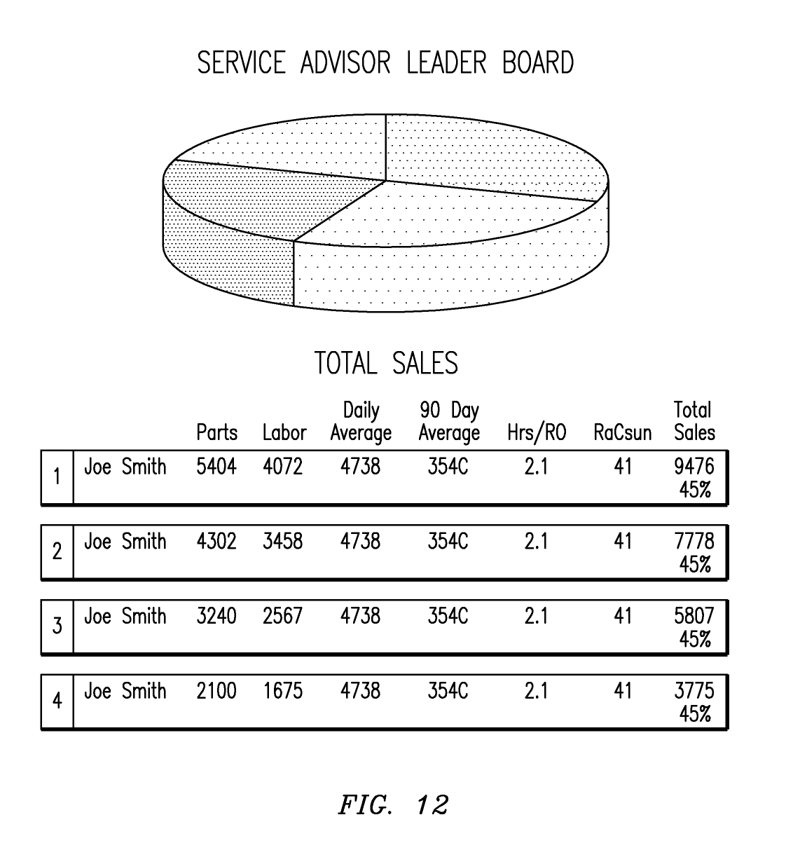

With reference to FIG. 11, an electronic display created for an automobile dealership using the system and method of the present invention is illustrated, which is self explanatory when viewed in conjunction with the description of the method and system described herein.

Finally with reference to FIG. 12, an electronic display created for an automobile service center using the system and method of the present invention is illustrated, which is self explanatory when viewed in conjunction with the description of the method and system described herein.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A method for transforming pre-existing sales data into an electronic display to be displayed on at least one video monitor, said method comprising the steps of:
a. a service provider acquiring sales data from a subscriber's database;
b. storing the acquired sales data on the service provider's database;
c. transforming the acquired sales data into an electronic display resembling a conventional sales tracking white board;
d. transmitting the graphical display to at least one video monitor located at the subscriber's place of business; and
e. displaying the graphical display on at least one video monitor.

2. The method of claim 1 wherein:
said sales data is acquired from an accounting database.

3. The method of claim 1 further comprising the steps prior to step b of:
said sales data being stored in text files;
said text files being transferred to the service provider from the subscriber's database via posting to and retrieving from an FTP server; and
said text files being opened by the service provider.

4. The method of claim 1 wherein:
said graphical display is saved as a web page on the service provider's web server; and
said web pages are displayed on the at least one video monitor via the Internet.

5. The method of claim 4 wherein:
said graphical display has a predetermined life cycle.

6. The method of claim 5 further comprising the steps of:
said predetermined life cycle expiring;
a new graphical display being created using current sales data acquired from the subscriber;
the new graphical display being transmitted to the at least one video monitor located at the subscriber's place of business; and
displaying the graphical display on the at least one video monitor.

7. The method of claim 1 wherein said sales data further comprises:
inventory information.

8. The method of claim 1 wherein said sales data further comprises:
salesperson information.

9. The method of claim 1 wherein said sales data further comprises:
product information.

10. The method of claim 1 wherein said sales data further comprises:
sales information.

11. The method of claim 1 wherein said graphical display further comprises:
identifying information for at least one sales person.

12. The method of claim 11 wherein said graphical display further comprises:
a month to date sales total for the at least one sales person.

13. The method of claim 11 wherein said graphical display further comprises:
a year to date sales total for the at least one sales person.

14. The method of claim 11 wherein said graphical display further comprises:
an average sales total for a predetermined amount of time for the at least one sales person.

15. The method of claim 11 wherein said graphical display further comprises:
a customer satisfaction index score for the at least one sales person.

16. The method of claim 11 wherein said graphical display further comprises:
an icon for each sale the at least one salesperson made during a predetermined period of time located near the at least one salesperson's identifying information.

17. The method of claim 16 wherein:
said icon contains information regarding a product sold during the sale the icon represents.

18. A system for transforming pre-existing sales data into an electronic display to be displayed on at least one video monitor, said comprising:
a service provider acquiring sales data from a subscriber's database;
storing the acquired sales data on the service provider's database;
transforming the acquired sales data into an electronic display resembling a conventional sales tracking whiteboard;
transmitting the graphical display to at least one video monitor located at the subscriber's place of business; and
displaying the graphical display on the at least one video monitor.

19. The system of claim 18 wherein:
said sales data is acquired from an accounting database.

20. The system of claim 18 further comprising:
said sales data sales data being stored in text files;
said text files being transferred to the service provider from the subscriber's database; and
said text files being opened by the service provider.

21. The system of claim 18 wherein:
said graphical display is saved as a web page on the service provider's web server; and
said web pages are displayed on the at least one video monitor via the Internet.

22. The system of claim 21 wherein:
said graphical display has a predetermined life cycle.

23. The system of claim 22 further comprising:
said predetermined life cycle expiring;
a new graphical display being created using current sales data acquired from the subscriber;
the new graphical display being transmitted to the at least one video monitor located at the subscriber's place of business; and
displaying the graphical display on the at least one video monitor.

24. The system of claim 18 wherein said sales data further comprises:
inventory information.

25. The system of claim 18 wherein said sales data further comprises:
salesperson information.

26. The system of claim 18 wherein said sales data further comprises:
product information.

27. The system of claim 18 wherein said sales data further comprises:
sales information.

28. The system of claim 18 wherein said graphical display further comprises:
identifying information for at least one sales person.

29. The system of claim 18 wherein said graphical display further comprises:
a month to date sales total for the at least one sales person.

30. The system of claim 18 wherein said graphical display further comprises:
a year to date sales total for the at least one sales person.

31. The system of claim 18 wherein said graphical display further comprises:
an average sales total for a predetermined amount of time for the at least one sales person.

32. The system of claim 18 wherein said graphical display further comprises:
a customer satisfaction index score for the at least one sales person.

33. The system of claim 18 wherein said graphical display further comprises:
an icon for each sale the at least one salesperson made during a predetermined period of time located near the at least one salesperson's identifying information.

34. The system of claim 16 wherein:
said icon contains information regarding a product sold during the sale the icon represents.
